(19) United States
(12) Patent Application Publication
(10) Pub. No.: US 2010/0009190 A1
(43) Pub. Date: Jan. 14, 2010

(54) METHOD FOR MANUFACTURING NIOBIUM OXIDE, NOBIUM OXIDE OBTAINED BY THIS MANUFACTURING METHOD, METHOD FOR MANUFACTURING NIOBIUM PHOSPHATE AND NIOBIUM PHOSPHATE OBTAINED BY THIS MANUFACTURING METHOD

(76) Inventors: TAKEO YAMAGUCHI, Kanagawa (JP); Taichi Ito, Kanagawa (JP); Natsuhiko Kono, Tochigi (JP); G.M. Anil Kumar, Aichi (JP)

Correspondence Address: WALL & TONG , LLP, 595 SHREWSBURY AVE., SHREWSBURY, NJ, 07702, US

(21) Appl. No.: 12/369,937

(22) Filed: Feb. 12, 2009

(30) Foreign Application Priority Data
Jul. 9, 2008 (JP) P2008-178880

(51) Int. Cl. C01G 33/00

(52) U.S. Cl. 428/402; 423/594.17; 423/305

(57) ABSTRACT

Disclosed are niobium oxide having a high catalytic activity and high performance niobium phosphate. Niobium oxide is prepared by reacting a niobium compound, a chelating agent and a catalyst in a solvent in an inert gas atmosphere. Niobium oxide thus prepared is added phosphoric acid for phosphorylation in order to prepare niobium phosphate.

### CROSS REFERENCES TO RELATED APPLICATION

The present invention contains subject matter related to Japanese Patent Application JP2008-178880 filed in the Japanese Patent Office on Jul. 9, 2008, which is incorporated herein by reference in its entirety.

### FIELD OF THE INVENTION

This invention relates to a method for manufacturing niobium oxide having a nano-order particle size, niobium oxide obtained by this manufacturing method, a method for manufacturing niobium phosphate for use as a high performance electrolyte material, and niobium phosphate obtained by this manufacturing method.

### BACKGROUND

A polymer electrolyte fuel cell (PEFC) has a high output density and may be manufactured to a small size with a light weight. Hence, it is expected to be applied to automobiles, co-generation systems for domestic use, and mobile equipment. However, for practical use, there is a raised demand for further improving the performance. To this end, it is necessary to improve the performance of an electrolyte or a catalytic component in a membrane electrode assembly, and a new material is desirably to be introduced.

One of the candidates for new materials for PEFC is niobium phosphate (NbOPO4.nH2O). In many cases, niobium phosphate has an amorphous structure and can be crystallized by sintering at an elevated temperature of 1000° C. Also, niobium phosphate is insoluble in water and shows strong acidity, with its Hammett acidity function Ho being such that Ho≦−8.2. It is mainly searched as a catalyst (see Non-Patent Publications 1 to 6, for example). The excellent catalytic activity of this niobium phosphate is mainly derived from Bronsted acid (Nb—OH and P—OH) and hence is felt to possess a high proton donating capability. It is thus felt that niobium phosphate may be used as a catalyst for a cathode electrode material or as an electrolyte material for PEFC.

Several non-patent publications may provide information of interest, including: Silva et al. Journal of Materials Science Letters 18 (1999) 197-200; Armaroni et al. Journal of Molecular Catalysis A: Chemical 151 (2000) 233-243; Mal et al. Chem. Commun. (2002) 2702-2703; Mal et al. Chem. Commun. (2003) 872-873; Sun et al. Journal of Catalysis 244 (2006) 1-9; and Sun et al. Journal of Molecular Catalysis A: Chemical 275 (2007) 183-193.

### BRIEF SUMMARY OF THE INVENTION

In case niobium phosphate is used for PEFC, it is desirable to prepare its hybrid material with a polymer from the perspective of durability of performance as e.g. an electrolyte material. Also, in case niobium phosphate is used for PEFC, it is desirable to fabricate it in the form of nano-order particles for demonstration of its high performance. In the related method for manufacturing niobium phosphate, higher temperatures exceeding the thermal resistance temperature of the polymer is desired in the process of phosphorylation of niobium oxide (Nb2O5) to prepare niobium phosphate. As a result, niobium phosphate assumes the shape of coarse particles. It is thus difficult to maintain the performance of niobium phosphate as an electrolyte material, and hence the resulting product is not proper to use as a hybrid material. Moreover, in fabricating such nano-sized niobium phosphate, niobium oxide as a niobium phosphate precursor is also desired to be comminuted in particle size to elevate its catalytic activity.

It is therefore an object of the present invention to solve the above problem and to provide a method for manufacturing comminuted niobium oxide having a high catalytic activity, and niobium oxide obtained by this manufacturing method.

It is another object of the present invention to provide a method for manufacturing niobium phosphate at lower temperatures by using niobium oxide obtained as described above, and niobium phosphate obtained by this method.

A method for manufacturing niobium oxide according to an embodiment of the present invention includes charging a niobium compound, a chelating agent and a catalyst in a solvent and reacting them together in an inert gas atmosphere.

Niobium oxide according to an embodiment of the present invention is manufactured by a method including charging a niobium compound, a chelating agent and a catalyst in a solvent and reacting them together in an inert gas atmosphere. It has a volume averaged particle size as measured by a dynamic light scattering method of 0.9 nm to 12 nm.

A method for manufacturing niobium phosphate according to an embodiment of the present invention includes a first step of reacting a niobium compound, a chelating agent and a catalyst in a solvent in an inert gas atmosphere, and a second step of adding phosphoric acid to a compound obtained in the first step.

Niobium phosphate according to an embodiment of the present invention is manufactured by a method including a first step of reacting a niobium compound, a chelating agent and a catalyst in a solvent in an inert gas atmosphere, and a second step of adding phosphoric acid to a compound obtained in the first step. It has a proton conductivity value not lower than 5.3×10−5 Scm−1.

According to an embodiment of the present invention, the particle size of niobium oxide may be comminuted by adding a chelating agent and hence its catalytic activity may be elevated. In addition, according to an embodiment of the present invention, niobium phosphate may be manufactured at lower temperatures by employing this niobium oxide. Hence, the performance of niobium phosphate as an electrolyte material may be more sustainable, so that this niobium phosphate may be used as an organic/inorganic hybrid material for PEFC.

### BRIEF DESCRIPTION OF THE DRAWINGS

The teachings of the present embodiments can be readily understood by considering the following detailed description in conjunction with the accompanying drawings, in which:

FIG. 1 is a flowchart for illustrating an example method for manufacturing niobium oxide.

FIG. 2 is a flowchart for illustrating an example method for manufacturing niobium phosphate.

FIG. 3 is a graph showing volume averaged particle size distributions of niobium oxide manufactured by adding a chelating agent.

FIG. 4A is a TEM photo of niobium oxide manufactured by adding a chelating agent, and FIG. 4B is a schematic view thereof.

FIG. 5 is a graph showing time changes of the volume averaged particle size distributions of niobium oxide manufactured by adding a chelating agent.

FIG. 6 is a graph showing time changes of the volume averaged particle size distributions of niobium oxide manufactured without adding a chelating agent.

FIG. 7 is a TEM photo of niobium oxide manufactured without adding a chelating agent.

FIG. 8 is a graph showing an FTIR spectrum of niobium phosphate obtained by adding a chelating agent and using 5M phosphoric acid.

FIG. 9 is a graph showing an XRD pattern of niobium phosphate obtained by adding a chelating agent and using 5M phosphoric acid.

FIG. 10 is a SEM photo of niobium phosphate obtained by adding a chelating agent and using 5M phosphoric acid.

FIG. 11 is a TEM photo of niobium phosphate obtained by adding a chelating agent and using 5M phosphoric acid.

FIG. 12 is a graph showing an FTIR spectrum of niobium phosphate obtained by adding a chelating agent and using 1M phosphoric acid.

FIG. 13 is a graph showing an XRD pattern of niobium phosphate obtained by adding a chelating agent and using 1M phosphoric acid.

FIG. 14 is a graph showing an FTIR spectrum of niobium phosphate obtained by using 5M phosphoric acid without adding a chelating agent.

FIG. 15 is a graph showing an XRD pattern of niobium phosphate obtained by using 5M phosphoric acid without adding a chelating agent.

FIG. 16 is a graph showing an XRD pattern before and after hydrothermal processing of niobium phosphate obtained by adding a chelating agent using 5M phosphoric acid.

FIG. 17(A) is a graph showing the result of thermogravimetry of niobium phosphate obtained by adding a chelating agent using 5M phosphoric acid, and FIG. 17(B) is a graph showing a portion X of FIG. 17(A) to an enlarged scale.

FIG. 18 is a graph showing proton conductivity of a phosphorylated zirconium compound and niobium phosphate obtained by adding a chelating agent using 5M phosphoric acid.

To facilitate understanding, identical reference numerals have been used, where possible, to designate identical elements that are common to the figures.

### DETAILED DESCRIPTION OF THE INVENTION

Various embodiments of the present invention will now be described with reference to the drawings. In the method for manufacturing niobium oxide according to the present embodiment, a niobium compound, a chelating agent and a catalyst as feedstock materials are added to a solvent, and niobium oxide is generated by the reaction of hydrolysis and polycondensation, generally known as a sol-gel method, of a metal alkoxide.

The feedstock materials are used in a state dispersed or dissolved in a solvent. Such a solvent in which a niobium compound is soluble is used. Examples of the solvent include alcohols, such as methanol, ethanol, 1-propanol, 2-propanol, 2-methoxy ethanol, 2-ethoxy ethanol, 1-butanol, ethylene glycol monoalkylether, propylene glycol monoalkylether, polyethylene glycol monoalkylether, and polypropylene glycol monoalkylether, polyhydric alcohols, such as ethylene glycol, propylene glycol, polyethylene glycol, polypropylene glycol and glycerin, carbonate compounds, such as ethylene carbonate and propylene carbonate, cyclic ethers, such as dioxane and tetrahydrofuran, chained ethers, such as diethylether, ethylene glycol dialkylether, and polypropylene dialkylether, nitrile compounds, such as acetonitrile, glutarodinitrile, methoxy acetonitrile, propionitryl and benzonitrile, esters, such as carboxylates, phosphates and phosphonates, non-protonic polar substances, such as dimethyl sulphoxide, sulfolane, dimethylformamide and dimethylacetoamide, non-polar solvents, such as toluene or xylene, chlorine-based solvents, such as methylene chloride or ethylene chloride, and water. Of these, alcohols with not more than two carbon atoms, such as methanol or ethanol, are preferred. The solvents may be used either singly or in combination.

The niobium compounds are substances that donate element niobium. For example, niobium alkoxide (Nb(OR)₅) may be used, where R denotes straight-chained or branched alkyl groups, preferably with 1 to 24 carbon atoms and more preferably with 1 to 10 carbon atoms. These alkyl groups may be enumerated by methyl, ethyl, propyl, i-propyl, i-butyl, pentyl, hexyl, octyl, 2-ethylhexyl, t-octyl, decyl, dodecyl, tetradecyl, 2-hexyldecyl, hexadecyl, octadecyl, cyclohexylmethyl and octylcyclohexyl groups.

As chelating agents, those that may exhibit a chelating effect on a niobium atom to control the particle size of niobium oxide to suppress the reaction of hydrolysis or polycondensation, are used. For example, acetoacetate esters, such as ethyl acetoacetate, 1,3-diketones, such as acetylacetone and 3-methyl-2,4-pentanedione, and acetoacetamides, such as N,N′-dimethyl aminoacetoacetamide, are used. Of these, 3-methyl-2,4-pentanedione is preferred because this compound demonstrates a high chelating effect and allows for an efficient phosphorylation reaction which will be described below in detail. For example, if an alcoholic solvent is used as a solvent, 3-methyl-2,4-pentanedione acts as a chelating agent satisfactorily because it has low affinity with the alcoholic solvent. The concentration of the chelating agent is preferably about thrice or four times, more preferably about four times that of niobium atoms in terms of the molar ratio. With the use of this concentration, it is possible to prevent atoms of the chelating agents from repelling one another to lower the chelating effect, thereby enabling niobium oxide to be produced with the nano-order particle size.

The catalysts are added to initiate the reaction of hydrolysis as well as polycondensation of the niobium compound. As the catalyst, an acid or an alkali may be used. As an acid, organic or inorganic protonic acids may be used. The inorganic protonic acid may be enumerated by, for example, hydrochloric acid, sulfuric acid, boric acid, nitric acid, perhydrochloric acid, tetrafluoroboric acid, hexafluoroarsenic acid, and hydrobromic acid may be used. The organic protonic acid may be enumerated by, for example, acetic acid, oxalic acid and methanesulfonic acid. The alkali may be enumerated by, for example, hydroxides of alkali metals such as sodium hydroxide, and ammonia. These catalysts may be used alone or in combination. For example, if nitric acid is used as a catalyst, the amount of water used with nitric acid is preferably kept constant at approximately 1M. With this concentration, it is possible to prevent the chelating effect by the chelating agent from becoming insufficient to prevent the particle size of niobium oxide from increasing excessively as a result of the polycondensation reaction.

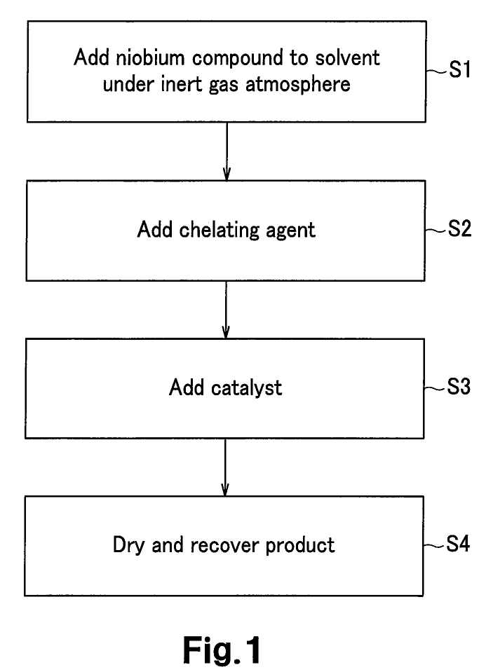

An example sequence of fabricating niobium oxide is now described with reference to a flowchart shown in FIG. 1. Initially, a niobium compound as a feedstock material is added to the solvent in an inert gas atmosphere (step S1). As the inert gas, for example, a nitrogen gas or an argon gas may be used.

A chelating agent is then added to the solvent containing the niobium compound (step S2).

A catalyst then is added to the solvent in which the chelating agent is added (step S3). For example, if 3-methyl-2,4-pentanedione (shown by the chemical formula 1 depicted below) . . .

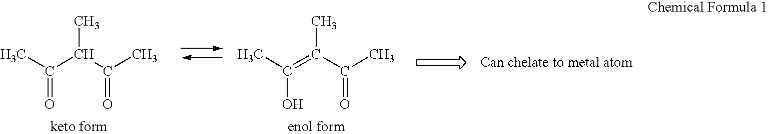

has been added as the chelating agent to niobium ethoxide as the niobium compound, a chemical reaction shown by the following chemical formula 2 proceeds:

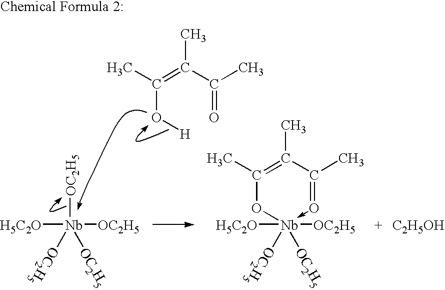

For example, in a polar solvent such as alcohol solvent, the proportion of the enol form of 3-methyl-2,4-pentanedione becomes higher than that of the keto form as indicated by the chemical formula 1, thus demonstrating the effect as the chelating agent more strongly. That is, the proton is desorbed from the C—OH part of 3-methyl-2,4-pentanedione so that the C—OH part is turned into an anion. This C—OH part thus turned into the anion is combined with niobium by a nucleophilic reaction. An oxygen atoms of the C═O part of 3-methyl-2,4-pentanedione interacts with niobium, as a result of which 3-methyl-2,4-pentanedione acts as a bidentate ligand. In this manner, the chelating agent substitutes the alkoxide site of the niobium compound in its entirety to retard the progress of the reaction of hydrolysis by water molecules and the polycondensation reaction to allow for comminuting the particle size of niobium oxide. That is, the chelating agent increases the surface area of niobium oxide to improve the catalytic activity.

The solvent then is dried to recover a dried product, that is, niobium oxide (step S4). The chelating effect comes into operation at the time of drying in the step S4 to prevent excessive growth in the particle size of niobium oxide. It should be noted that, in case no chelating agent is added to niobium oxide at the time of drying in the step S4, it is more probable that growth in particle size of the niobium oxide particles occurs in the course of drying, with the result that it becomes difficult to manufacture niobium oxide with the nano-scale particle size.

Thus, with the present method for manufacturing niobium oxide, it is possible to manufacture niobium oxide with the nanoscale particle size. By niobium oxide with a nanoscale particle size is meant niobium oxide having a volume averaged particle size as measured by the dynamic light scattering method in a range from 0.9 nm to 12 nm. Hence, with the present method for manufacturing niobium oxide, niobium oxide may be comminuted in particle size, so that niobium oxide having high catalytic activity may be manufactured. Niobium oxide thus manufactured may be used e.g. as a precursor for an electrolyte material of a polymer electrolyte fuel cell which is hereinafter explained.

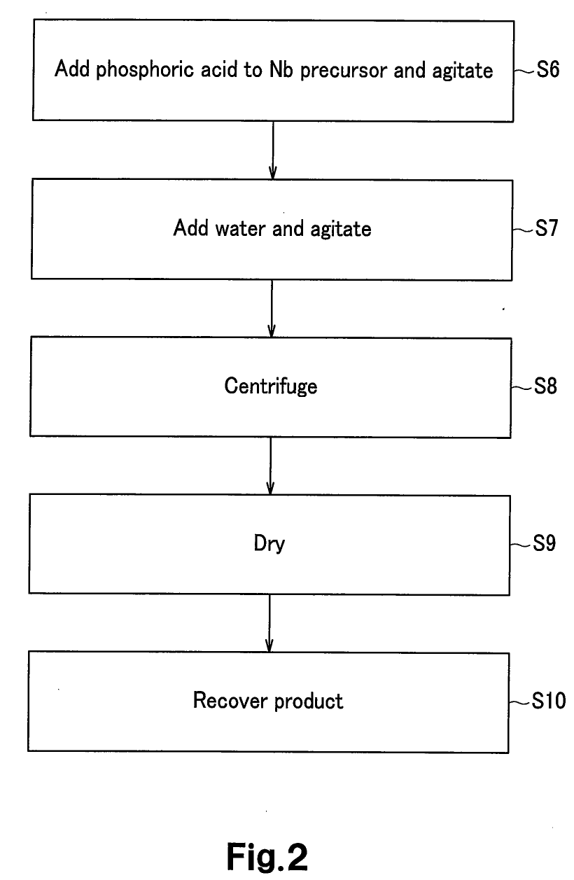

An example sequence for generating niobium phosphate by phosphorylating niobium oxide with a nanoscale particle size generated as described above is now described with reference to a flowchart shown in FIG. 2. It is noted that niobium oxide with the nanoscale particle size is referred to below as a niobium phosphate precursor, and that niobium phosphate may be used as an electrolyte material of a polymer electrolyte fuel cell.

Initially, phosphoric acid (H₃PO₄) is added to the niobium phosphate precursor (Nb precursor), and the resulting mass is agitated (step S6). It is noted that phosphoric acid is used to build a basic skeleton of niobium phosphate to increase the catalytic activity. Preferably, the concentration of phosphoric acid is on the order of 1M to 5M, for instance. With the concentration of phosphoric acid of 1M to 5M, it is possible to prevent the skeleton of niobium phosphate from failing to be formed in order to get the sufficient catalytic activity.

If, by the above-described method for manufacturing the niobium phosphate precursor using the chelating agent, the particle size of the niobium phosphate precursor produced is the nano-order size, the number of reaction sites for niobium after cessation of the chelating action of the chelating agent is increased. Hence, it becomes possible to proceed with the phosphorylation reaction more efficiently. Specifically, with the use of the chelating agent, the energy needed for phosphorylating the niobium phosphate precursor, for example, the reaction at an elevated temperature, may be dispensed with. That is, the niobium phosphate precursor may be phosphorylated under low temperature conditions.

Preferably, the time for agitation is sufficiently long to permit the basic skeleton of niobium phosphate to be formed, for example, 40 hours or longer. The temperature during the agitation is preferably on the order of 40 to 80° C. and most preferably on the order of 80° C. in order to take account of the yield of niobium phosphate.

Niobium phosphate obtained in the step S6 is added by water, and the resulting mass is agitated (step S7). Water added is to be free of foreign matter, for instance, water obtained on reverse osmosis (Ro water).

Niobium phosphate is then isolated from phosphoric acid by centrifugation, and the liquid supernatant is removed (step S8). It should be noted that the operations of the steps S7 and S8 are carried out repeatedly so that phosphoric acid will be removed sufficiently. Niobium phosphate obtained in the step S8 is dried (step S9) and recovered (step S10).

With the present method for manufacturing niobium phosphate, the niobium phosphate precursor with the nanoscale particle size may be manufactured by using the chelating agent in the above method for manufacturing the niobium phosphate precursor. Hence, the niobium phosphate precursor may have an increased surface area and hence may be improved in its catalytic activity. With the use of this niobium phosphate precursor having the high catalytic activity, it is possible to phosphorylate the niobium phosphate precursor under low temperature conditions, such that it is possible to manufacture niobium phosphate having a proton conductivity value at 90° C. of more than 5.3×10⁻⁵ Scm⁻¹. That is, with the present method for manufacturing niobium phosphate, in which niobium phosphate with high proton conductivity may be produced, it is possible to improve the performance of niobium phosphate as electrolyte. Hence, niobium phosphate may be applied as an organic/inorganic hybrid material for PEFC.

The present invention is now described with reference to Examples and Comparative Examples of the method for manufacturing the niobium phosphate precursor.

### EXAMPLE 1

Preparation of niobium phosphate precursor. In a first example, 200 ml. of methanol was charged into a beaker as a solvent. Then, in a nitrogen atmosphere, 2510 μl. (0.01 mol) of niobium ethoxide (Nb(OC₂H₅)₅) as a niobium compound was introduced into the beaker, and the resulting mass was agitated. After lapse of 30 minutes as from the start of agitation, 4650 μl. (0.04 mol) of 3-methyl-2,4-pentanedione as a chelating agent was introduced into the beaker. Thus, the amount of the chelating agent was in a molar quantity four times that of niobium atoms. After lapse of three hours as from the start of the agitation, 3000 μl. of 1M nitric acid was introduced into the beaker. After lapse of 15 hours as from the start of the agitation, the agitation was discontinued, and methanol in the beaker was dried at 80° C. on a hot plate. After the end of the drying, the niobium phosphate precursor left in the beaker was recovered.

In a second example, 20 ml. of methanol as a solvent, 251 μl. (0.001 mol) of niobium ethoxide as a niobium compound, 465 μl. (0.004 mol) of 3-methyl-2,4-pentanedione as a chelating agent, and 300 μl. of 1M nitric acid as a catalyst, were used. The amount of the chelating agent was thus in a molar quantity four times that of niobium atoms. Otherwise, the present Example 2 was carried in the same way as in Example 1.

In a third example, the process of example 2 was modified to use 20 ml. of ethanol as a solvent as a catalyst.

In a fourth example, the process of example 2 was modified to use 3-methyl-2,4-pentanedione in an amount of 0.003 mol, which is three times that of niobium atoms, as a chelating agent.

A Comparative Example 1 was carried out in the same way as in Example 1 except without adding the chelating agent.

A Comparative Example 2 was carried out in the same way as in Example 2, except using 20 ml. of 2-propanol as a solvent.

A Comparative Example 3 was carried out in the same way as in Example 2, except using 2M of nitric acid as a catalyst.

A Comparative Example 4 was carried out in the same way as in Example 2, except using 3-methyl-2,4-pentanedione as a chelating agent in an amount of 0.005 mol which is five times that of niobium atoms.

A Comparative Example 5 was carried out in the same way as in Example 2, except using 20 ml. of 2-propanol as a solvent and using acetyl acetone in an amount of 0.004 mol, which is four times that of niobium atoms, as a chelating agent.

A Comparative Example 6 was carried out in the same way as in Example 3, except using acetyl acetone in an amount of 0.004 mol, which is four times that of niobium atoms, as a chelating agent.

A Comparative Example 7 was carried out in the same way as in Example 3, except using acetyl acetone as a chelating agent, in the same molar quantity (0.001 mol) as that of niobium atoms.

A Comparative Example 8 was carried out in the same way as in Example 3, except using 0.002 mol of acetyl acetone, which is twice that of niobium atoms, as a chelating agent.

A Comparative Example 9 was carried out in the same way as in Example 3, except using 0.003 mol of acetyl acetone, which is three times that of niobium atoms, as a chelating agent.

A Comparative Example 10 was carried out in the same way as in Example 3, except using 0.004 mol of acetyl acetone, which is four times that of niobium atoms, as a chelating agent.

A Comparative Example 11 was carried out in the same way as in Example 3, except using acetyl acetone in the same molar quantity (0.001 mol) as that of niobium atoms as a chelating agent, and also except using 3M nitric acid as a catalyst.

A Comparative Example 12 was carried out in the same way as in Example 3, except using acetyl acetone in a molar quantity (0.002 mol) twice as that of niobium atoms as a chelating agent, and also except using 3M nitric acid as a catalyst.

A Comparative Example 13 was carried out in the same way as in Example 3, except using acetyl acetone in a molar quantity (0.003 mol) which is three times that of niobium atoms as a chelating agent, and using 3M nitric acid as a catalyst.

A Comparative Example 14 was carried out in the same way as in Example 3, except using acetyl acetone in a molar quantity (0.004 mol) which is four times that of niobium atoms as a chelating agent, and using 3M nitric acid as a catalyst.

The above Examples 1 to 4 and the Comparative Examples 1 to 14 are collectively shown in the following Table 1.

TABLE 1

| | | | | Nitric acid | | |
|---|---|---|---|---|---|---|
| | | Chelating | Chelating | conc. | Particle size | |
| | Solvent | agent | agent/Nb | [M] | [nm] | Remarks |
| Ex. 1 | Methanol | 3-methyl-2,4- | 4 | 1 | 2.1 | |
| | | penthanedione | | | | |
| Ex. 2 | methanol | 3-methyl-2,4- | 4 | 1 | 0.9 | |
| | | penthanedione | | | | |
| Ex. 3 | ethanol | 3-methyl-2,4- | 4 | 1 | 1.7 | |
| | | penthanedione | | | | |
| Ex. 4 | methanol | 3-methyl-2,4- | 3 | 1 | 1.2 | |
| | | penthanedione | | | | |
| Comp. | methanol | 3-methyl-2,4- | — | 1 | tens to | |
| Ex. 1 | | penthanedione | | | hundreds | |
| | | | | | of μm | |
| Comp. | 2-propanol | 3-methyl-2,4- | 4 | 1 | 155 | |
| Ex. 2 | | penthanedione | | | | |
| Comp. | methanol | 3-methyl-2,4- | 4 | 2 | — | |
| Ex. 3 | | penthanedione | | | | |
| Comp. | methanol | 3-methyl-2,4- | 5 | 1 | 50, 250 | |
| Ex. 4 | | penthanedione | | | | |
| Comp. | 2-propanol | acetylacetone | 4 | 1 | 220 | |
| Ex. 5 | | | | | | |
| Comp. | ethanol | acetylacetone | 4 | 1 | — | not |
| Ex. 6 | | | | | | dispersed |
| Comp. | ethanol | acetylacetone | 1 | 1 | — | not |
| Ex. 7 | | | | | | dispersed |
| Comp. | ethanol | acetylacetone | 2 | 1 | — | not |
| Ex. 8 | | | | | | dispersed |
| Comp. | ethanol | acetylacetone | 3 | 1 | — | not |
| Ex. 9 | | | | | | dispersed |
| Comp. | ethanol | acetylacetone | 4 | 1 | — | not |
| Ex. 10 | | | | | | dispersed |
| Comp. | ethanol | acetylacetone | 1 | 3 | — | not |
| Ex. 11 | | | | | | dispersed |
| Comp. | ethanol | acetylacetone | 2 | 3 | — | not |
| Ex. 12 | | | | | | dispersed |
| Comp. | ethanol | acetylacetone | 3 | 3 | — | not |
| Ex. 13 | | | | | | dispersed |
| Comp. | ethanol | acetylacetone | 4 | 3 | — | not |
| Ex. 14 | | | | | | dispersed |

The particle size of the precursors of niobium phosphate prepared in Examples and Comparative Examples shown in Table 1 was evaluated as follows:

In a first Test for Evaluation, the particle size was measured in accordance with the dynamic light scattering (DLS) method in N-methyl-2-pyrrolidone (N-methylpyrrolidone NMP) on a measurement device Zetasizer Nano manufactured by SISMEX Corporation. Also, particle size evaluation was made by observation with TEM and SEM.

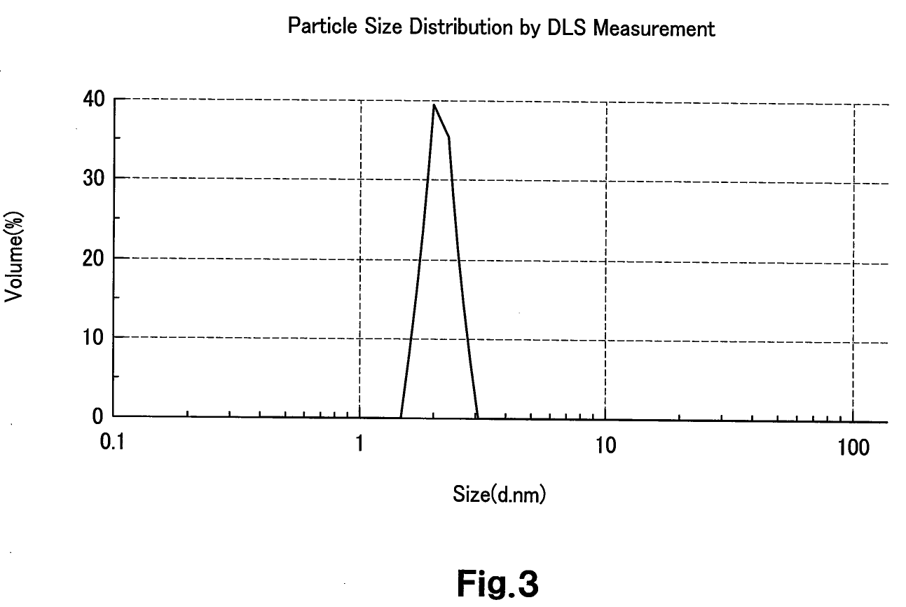

The result of particle size measurement of the niobium phosphate precursor of Example 1 is shown in FIG. 3, in which the abscissa denotes the particle size (particle diameter) of the niobium phosphate precursor in nm and the ordinate its volume in (%). It is seen from FIG. 3 that a peak may be observed at approximately 2.1 nm, and hence the particle size is approximately 2.1 nm.

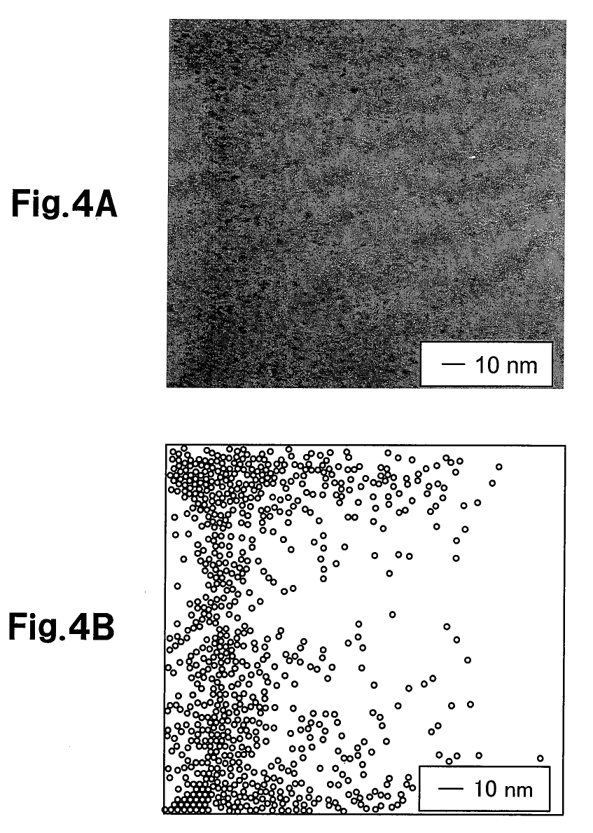

The result of photographing with TEM of the niobium phosphate precursor of Example 1, dispersed in methanol, is shown in a TEM photo of FIG. 4A and the schematic view of FIG. 4B. From this result of photographing, particles with the particle size on the order of 2 nm may be noticed. It may thus be seen from the results of FIGS. 3 and 4 that the niobium phosphate precursor is of the unit order (single-digit) nano-size.

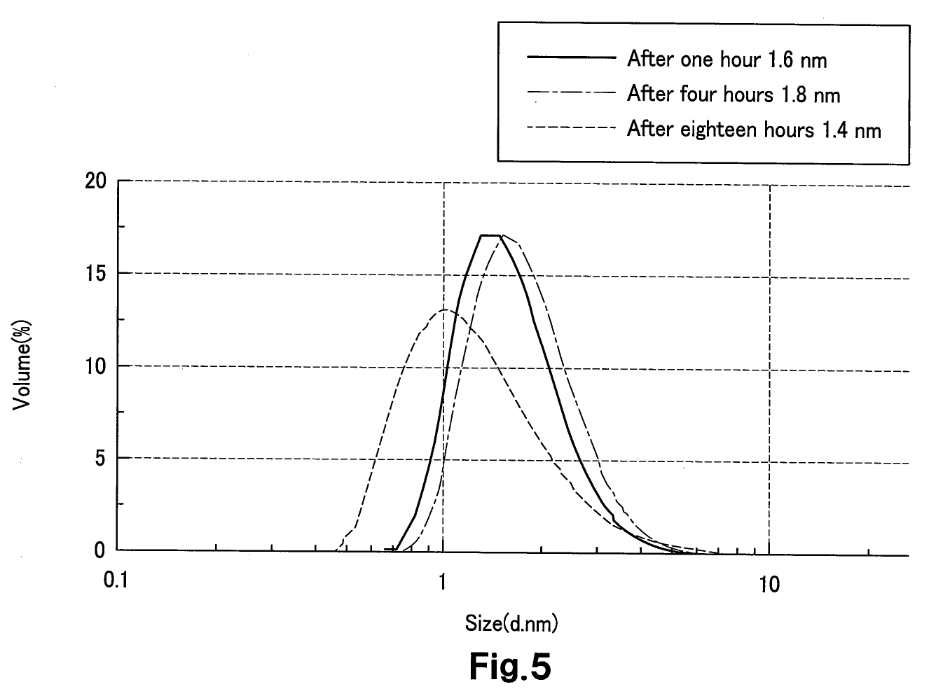

FIG. 5 depicts a graph showing changes with time of the distribution of the volume average particle size of the niobium phosphate precursor after addition of nitric acid. It is seen from FIG. 5 that the particle size of the niobium phosphate precursor after lapse of one hour, that after lapse of four hours and that after lapse of 18 hours is 1.6 nm, 1.8 nm and 1.4 nm, respectively. This indicates that the particle size of the niobium phosphate precursor remains substantially unchanged in the course of synthesis of the niobium phosphate precursor.

Thus, with Example 1, in which the progress of the reaction of polycondensation or hydrolysis of niobium ethoxide is retarded through the use of the chelating agent, it is possible to manufacture the niobium phosphate precursor with the nanoscale particle size.

The results of the evaluation for Examples 2 to 4, similar to that conducted for Example 1, are also shown in Table 1. It is seen from the results of Examples 2 to 4 that the niobium phosphate precursor having substantially the nanoscale particle size may be prepared in case the concentration of the solvent or that of the chelating agent used is changed.

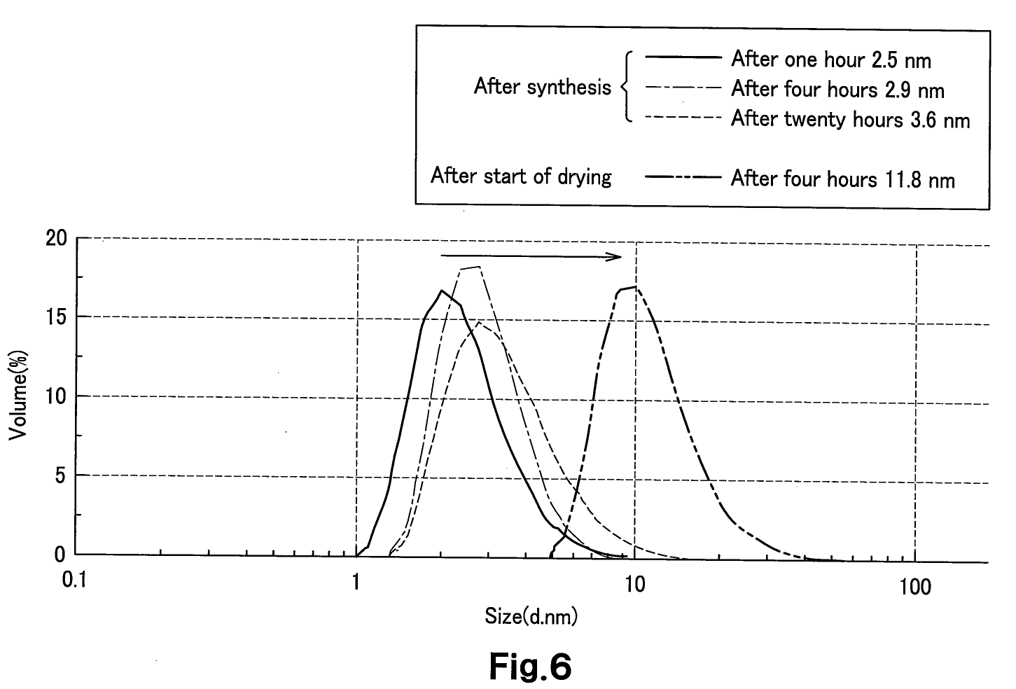

Conversely, with the Comparative Example 1, the particle size of the niobium phosphate precursor is 2.5 nm, 2.9 nm and 3.6 nm after lapse of one hour, four hours and 20 hours as from the time of addition of nitric acid, respectively, as shown in FIG. 6. After lapse of 4 hours as from the start of drying, the particle size was 11.8 nm. These results indicate that, since no chelating agent is added in the Comparative Example 1, the particle size of the niobium phosphate precursor is progressively increased in the course of the hydrolysis and polycondensation of niobium ethoxide, and that, in the drying process, the particle size is rapidly increased. Also, with the Comparative Example 1, precipitates of the niobium phosphate precursor were observed when the amount of the solvent methanol is about one-fourth. The fact that the precipitates were observed indicates that, with the Comparative Example 1, the particle size of the niobium phosphate precursor was rapidly increased in the drying step.

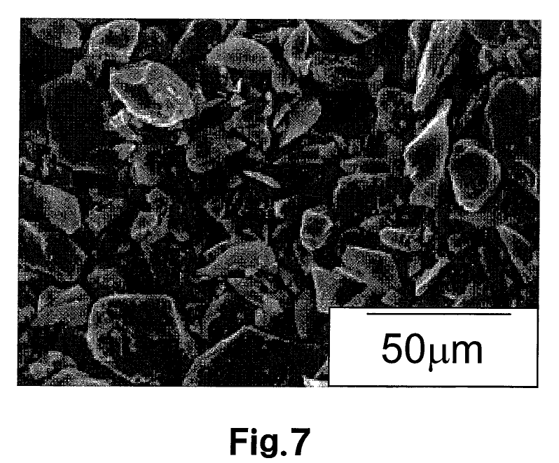

Also, the particles with the particle size of the order of several to tens of μm may be noticed in the results of observation over SEM shown in FIG. 7 of the niobium phosphate precursor of the Comparative Example 1 recovered after the drying. It is thus seen that, since no chelating agent is added in the Comparative Example 1, the particle size of particles tends to increase more readily due to the reaction of hydrolysis or polycondensation than with the Examples 1 to 4 to render it difficult to generate the niobium phosphate precursor with the nanoscale particle size.

Evaluation tests for the Comparative Examples 2 to 14 were conducted in the same way as that for the Comparative Example 1. It is seen from the results of evaluation tests for the Comparative Examples 2 to 14 that even in case of addition of the chelating agent, it might be difficult to manufacture the niobium phosphate precursor with the nanoscale particle size. It is thus seen that even in case of addition of the chelating agent, the manner of combinations of the solvent used with the chelating agent, the concentration of nitric acid and the concentration of the chelating agent with respect to niobium is crucial.

In a fifth example (preparation of niobium phosphate), 1.0 g. of the niobium phosphate precursor obtained in Example 1 was added to 50 ml. of 5M phosphoric acid to initiate the reaction of phosphorylation. After the end of the reaction of phosphorylation, 50 ml. of water obtained on reverse osmosis was added to a solution containing niobium phosphate and the resulting mass was agitated for one hour. Niobium phosphate was then isolated from phosphoric acid using a centrifuge, and phosphoric acid as a liquid supernatant was removed. Niobium phosphate was transferred to a beaker and added by 100 ml. of water obtained on reverse osmosis, and the resulting solution was agitated for one hour. After agitation, niobium phosphate was separated by a centrifuge from the water of reverse osmosis, and the liquid supernatant was removed. The above sequence of operations of separation was carried out three times. Niobium phosphate was dried at 80° C. by a drier.

A sixth example 6 was carried out in the same way as in Example 5, except using 50 ml. of 1M phosphoric acid.

A Comparative Example 15 was carried out in the same way as in Example 5 except using 50 ml. of 7M phosphoric acid.

A Comparative Example 16 was carried out in the same way as in Example 5 except using the niobium phosphate precursor obtained in Comparative Example 1.

The Examples 5, 6 and the Comparative Examples 15, 16 are collectively shown in the following Table 2.

TABLE 2

| | Concentration of | | |
|---|---|---|---|
| | phosphoric acid [M] | Yield [g] | Precursor |
| Ex. 5 | 5 | 0.59 | Ex. 1 |
| Ex. 6 | 1 | 0.69 | Ex. 1 |
| Comp. Ex 15 | 7 | 0.04 | Ex. 1 |
| Comp. Ex 16 | 5 | | Comp. Ex. 1 |

Evaluation of phosphorylation and the yield of niobium phosphate in each of the Examples and Comparative Examples of Table 2 was conducted by measurement by FTIR and XRD and observation over SEM and TEM. The results are as indicated below.

### Evaluation Test 2.

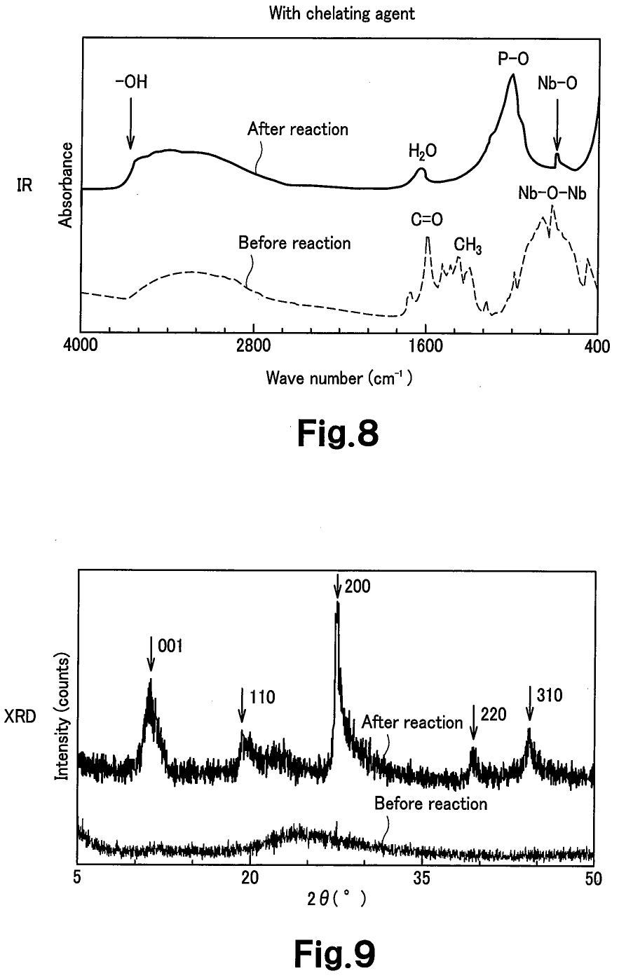

First, the valuation of the Examples 5, 6 and the Comparative Example 16 is explained. In an FTIR spectrum of FIG. 8 for Example 5, peaks of C═O and CH₃ linkages proper to 3-methyl-2,4-pentanedione as a chelating agent, and Nb—O—Nb, may be noticed before the reaction of phosphorylation. After the reaction of phosphorylation, a peak indicating a P—O linkage proper to phosphoric acid may be observed in the vicinity of 1010 cm⁻¹. It is thus seen that, with Example 5, a phosphoric acid group has been introduced as a basic skeleton to niobium of the niobium phosphate precursor as a result of the reaction of phosphorylation. Also, in Example 5, a peak in the vicinity of 1600cm⁻¹ proper to H₂O and a peak in the vicinity of 3700cm⁻¹ proper to an OH group may be noticed. These peaks observed in Example 5 proper to water, and they are in conformity to the fact that niobium phosphate usually exists in the form of a hydrate.

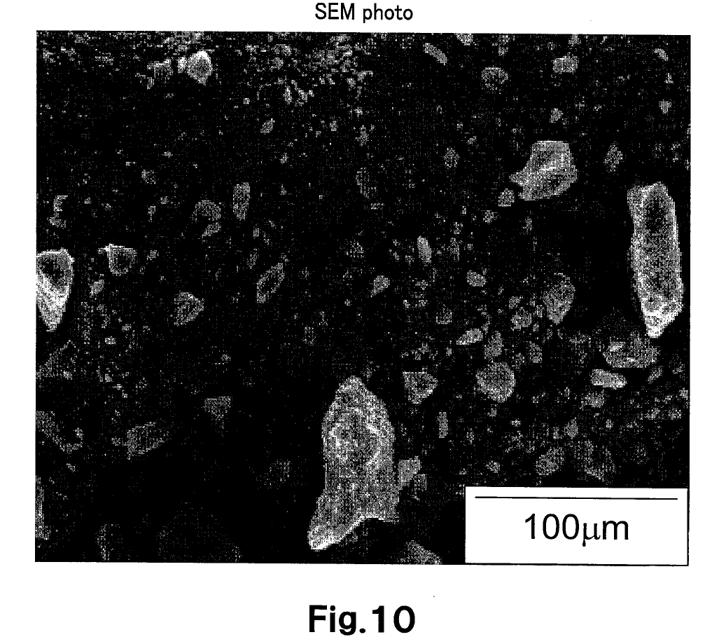

Also, in Example 5, there may be observed a peak indicating the crystallization on the (200) plane after the reaction of phosphorylation as indicated by XRD patterns before and after the reaction of phosphorylation shown in FIG. 9. Further, in Example 5, it may be seen from the results of observation over SEM shown in FIG. 10, that the particle size of niobium phosphate after the reaction of phosphorylation is several to tens of μm. Hence, in Example 5, it may be seen from the results of FIGS. 9 and 10 that the niobium phosphate precursor of the unit-order (single-digit) nano size assumes a globally crystalline structure as a result of growth of particles due to the reaction of phosphorylation, even though it does not take on an inherent crystalline structure.

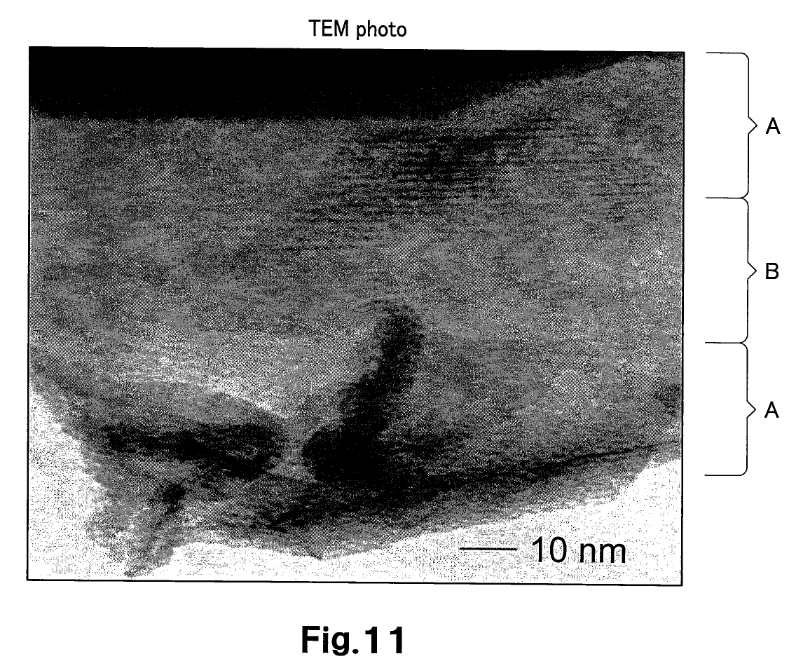

Further, the result of observation with the TEM shown in FIG. 11 indicates that niobium phosphate of Example 5 has an area with a clear linear pattern indicative of the crystalline structure (an area indicated by A in FIG. 11) and an area devoid of such clear linear pattern (an area indicated by B in FIG. 11). It is thus seen that a crystallized portion and an amorphous portion co-exist in niobium phosphate of Example 5.

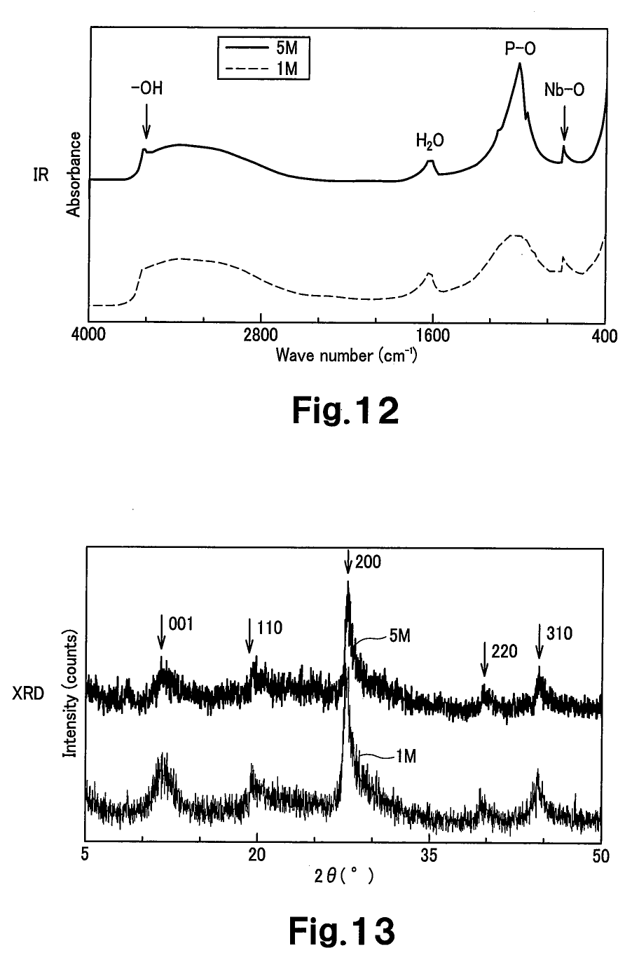

In Example 6, in which 1M of phosphoric acid indicated by a broken line in FIG. 12 is used, an IR spectrum proper to niobium phosphate may be noticed in the same way as when 5M phosphoric acid indicated by a solid line is used, that is, in the same way as in Example 5.

Also, in Example 6, a peak indicating crystallization may be noticed in the (200) plane in the XRD pattern shown in FIG. 13, in the same way as in Example 5.

Thus, in Example 6, in which 1M phosphoric acid is used, it may be seen that niobium phosphate which is the same as the product of Example 5 has been generated. That is, a crystallized structure and an amorphous structure co-exist in niobium phosphate of Example 6.

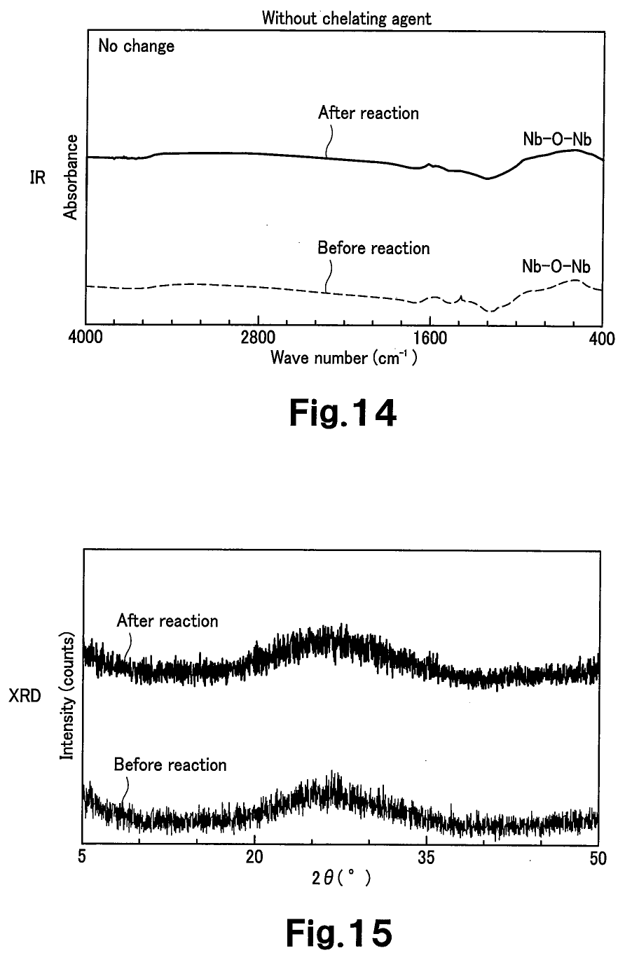

Conversely, in Comparative Example 16, there may be noticed no change before and after the reaction of phosphorylation as indicated from the FTIR spectrum of FIG. 14 and the XRD pattern of FIG. 15. It is thus seen that, with Comparative Example 16, there has not occurred phosphorylation of the niobium phosphate precursor.

The yields of the Examples 5 and 6 and the Comparative Examples 15 and 16 are now described. With the Examples 5 and 6, the yields of niobium phosphate are 0.59 g. and 0.69 g., respectively, whereas the yield of the Comparative Examples 15 is 0.04 g. and that of the Comparative Example 16 is none (not recovered). It is seen from these results that, with the Examples 5 and 6, phosphorylation of the niobium phosphate precursor proceeded satisfactorily, whereas, with the Comparative Examples 15 and 16, there scarcely occurred the process of phosphorylation of the niobium phosphate precursor.

### Evaluation Test 3.

Then, evaluation was made of the performance as the electrolyte material of niobium phosphate obtained in Example 5. That is, the compound was evaluated as to its hydrothermal stability, thermal resistance and proton conductivity by way of performance evaluation.

### Evaluation of Hydrothermal Stability.

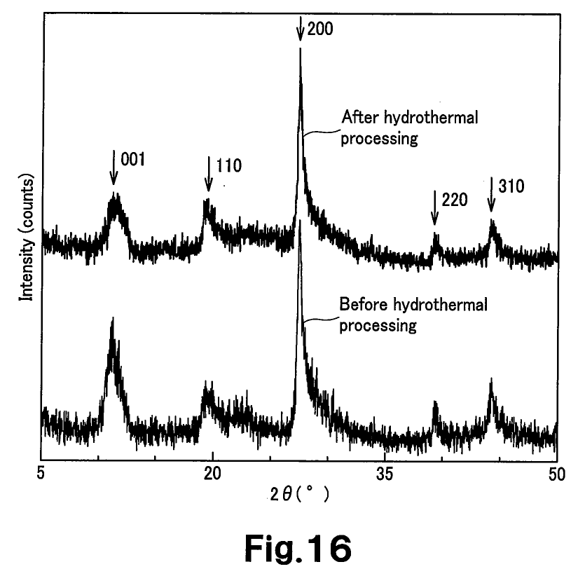

Niobium phosphate was agitated with 200 ml. of water from reverse osmosis for 24 hours, centrifuged and dried. The so treated niobium phosphate was recovered and evaluation was made of hydrothermal stability. In PEFC, water molecules are used to enhance the proton conductivity. Hence, the electrolyte material is desired to be stable under high temperature and high humidity conditions. Thus, 0.1 g. of niobium phosphate was added to 50 ml. of water obtained on reverse osmosis, and the resulting mass was heated in an oil bath at 100° C. for 24 hours to check for the effect the hot water has on niobium phosphate. To check for the effect the hot water has on niobium phosphate, an XRD pattern before hydrothermal processing and that after hydrothermal processing were compared to each other as shown in FIG. 16. It was seen that, even after the hydrothermal processing, there may be detected a peak indicating the crystal structure of niobium phosphate on the (200) plane. These detected results indicate that, since the peak position has scarcely been changed before and after the hydrothermal processing, there has occurred no change in the crystal structure of niobium phosphate with the compound being stable even in hot water.

### Evaluation of Thermal Resistance.

Niobium phosphate was agitated for 24 hours in 200 ml. of water from reverse osmosis, centrifuged and dried. The resulting mass of niobium phosphate was evaluated for thermal resistance. The evaluation for thermal resistance was conducted by thermogravimetry (TG) which is a technique of analysis by measurement of changes in weight that are caused when a specimen is heated and cooled at a regular speed or kept at a constant temperature.

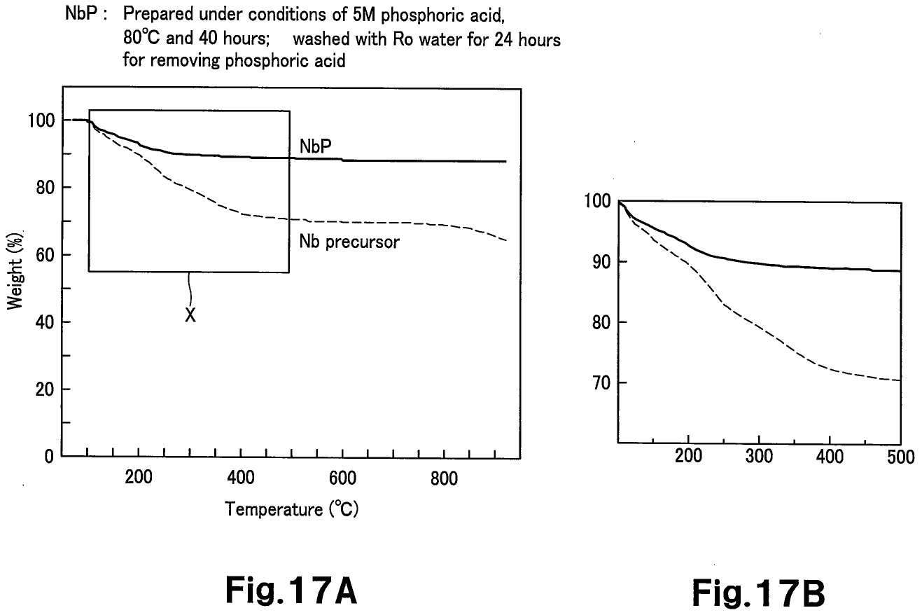

FIG. 17(A) shows the results of thermogravimetry of niobium phosphate prepared by using 5M phosphoric acid. FIG. 17(B) depicts an enlarged view of a portion X of FIG. 17(A). It is seen from comparison of thermal resistance before the reaction of phosphorylation indicated as ‘Nb precursor’, and that after the reaction of phosphorylation indicated as ‘NbP’, that the weight of the niobium phosphate precursor is gradually decreased with rise in temperature until the temperature exceeds 400° C. It is seen that the weight at the time of end of measurement of the niobium phosphate precursor is decreased to approximately 70% (two-thirds) of that at the start time of measurement.

On the other hand, decrease in the mass weight of niobium phosphate (NbP) at the time of end of the measurement is approximately 10% of that at the time of start of the measurement. It may be seen from these results that niobium phosphate exhibits high thermal resistance and may retain moisture up to a range of appreciably high temperatures. It may also be seen that niobium phosphate is scarcely subjected to decrease in the mass in a high temperature range, that is, that niobium phosphate is higher in thermal resistance than its precursor.

### Evaluation of Proton Conductivity.

Evaluation was made of proton conductivity of niobium phosphate obtained on agitation of niobium phosphate in 200 ml. of water obtained by the reverse osmosis, followed by centrifugation and drying. The proton conductivity of niobium phosphate was measured by an impedance method. Specifically, niobium phosphate was pelletized by pressurization and casting by using a pressurizing device and a vacuum device. The proton conductivity of the pelletized niobium phosphate was measured by connecting platinum wires on its both ends and by clamping it from both sides by glass plates.

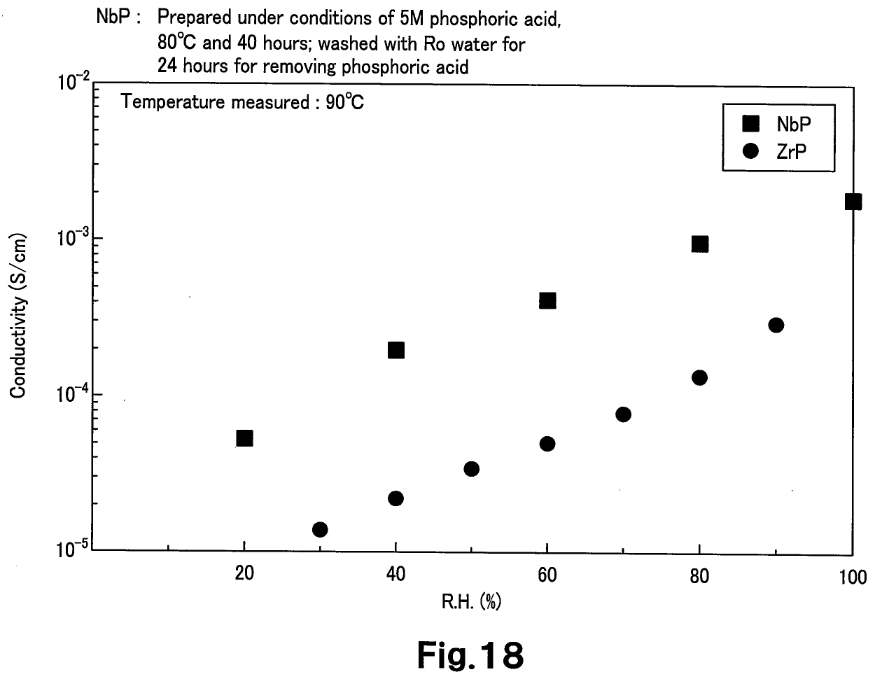

The results of measurement of proton conductivity of niobium phosphate at 90° C. showed that the proton conductivity for relative humidity of 20 to 100% was 5.3×10⁻⁵ to 1.9×10⁻³ Scm⁻¹ as indicated in FIG. 18. That is, niobium phosphate indicated high proton conductivity in proportion to humidity. It is also seen from FIG. 18 that the proton conductivity of niobium phosphate is higher than that of a phosphorylated zirconia (ZrP) compound as measured under the same measurement conditions. It is seen from these results that niobium phosphate may be used as a proton conductor.

With the method for manufacturing niobium phosphate precursor described above, it is possible to manufacture a niobium phosphate precursor having the nanoscale particle size through the use of 3-methyl-2,4-pentanedione as a chelating agent. By phosphrylating this precursor having the nanoscale particle size, niobium phosphate may be manufactured at a temperature of 80° C. which is lower than that of the related method. Niobium phosphate, which is ordinarily desired to be sintered at approximately 1000° C. for crystallization, may be partially crystallized at a temperature as low as 80° C. Hence, niobium phosphate having high proton conductivity and a sustainable performance as an electrolyte material may be used as an organic/ inorganic hybrid material for PEFC.

While the foregoing is directed to various embodiments of the present invention, other and further embodiments of the invention may be devised without departing from the basic scope thereof. As such, the appropriate scope of the invention is to be determined according to the claims, which follow.

What is claimed is:

1. A method for manufacturing niobium oxide comprising reacting a niobium compound, a chelating agent and a catalyst in a solvent in an inert gas atmosphere.

2. The method for manufacturing niobium oxide according to claim 1, wherein said chelating agent is 3-methyl-2,4-pentanedione.

3. The method for manufacturing niobium oxide according to claim 1, wherein said niobium compound is niobium ethoxide (Nb(OC₂Hs)₅).

4. The method for manufacturing niobium oxide according to claim 2, wherein said niobium compound is niobium ethoxide (Nb(OC₂H₅)₅).

5. The method for manufacturing niobium oxide according claim 1, wherein said solvent is at least one of methanol and ethanol.

6. The method for manufacturing niobium oxide according claim 2, wherein said solvent is at least one of methanol and ethanol.

7. The method for manufacturing niobium oxide according claim 3, wherein said solvent is at least one of methanol and ethanol.

8. Niobium oxide manufactured by the manufacturing method according to claim 1 and having a volume averaged particle size as measured by a dynamic light scattering method of 0.9 nm to 12 nm.

9. Niobium oxide manufactured by the manufacturing method according to claim 2 and having a volume averaged particle size as measured by a dynamic light scattering method of 0.9 nm to 12 nm.

10. Niobium oxide manufactured by the manufacturing method according to claim 3 and having a volume averaged particle size as measured by a dynamic light scattering method of 0.9 nm to 12 nm.

11. Niobium oxide manufactured by the manufacturing method according to claim 5 and having a volume averaged particle size as measured by a dynamic light scattering method of 0.9 nm to 12 nm.

12. A method for manufacturing niobium phosphate, comprising:
a first step of reacting a niobium compound, a chelating agent and a catalyst in a solvent in an inert gas atmosphere; and
a second step of adding phosphoric acid to a compound obtained in said first step.

13. The method for manufacturing niobium phosphate according to claim 12, wherein said chelating agent is 3-methyl-2,4-pentanedione.

14. The method for manufacturing niobium phosphate according to claim 12, wherein said niobium compound is niobium ethoxide (Nb(OC₂H₅)₅).

15. The method for manufacturing niobium phosphate according to claim 13, wherein said niobium compound is niobium ethoxide (Nb(OC₂H₅)₅).

16. The method for manufacturing niobium phosphate according to claim 12, wherein said solvent is at least one of methanol and ethanol.

17. The method for manufacturing niobium phosphate according to claim 13, wherein said solvent is at least one of methanol and ethanol.

18. The method for manufacturing niobium phosphate according to claim 14, wherein said solvent is at least one of methanol and ethanol.

19. The method for manufacturing niobium phosphate according to claim 12, further comprising:
a third step of washing a compound obtained by said second step of addition of phosphoric acid with water and drying a resulting product.

20. The method for manufacturing niobium phosphate according to claim 13, further comprising:
a third step of washing a compound obtained by said second step of addition of phosphoric acid with water and drying a resulting product.

21. The method for manufacturing niobium phosphate according to claim 14, further comprising:
a third step of washing a compound obtained by said second step of addition of phosphoric acid with water and drying a resulting product.

22. The method for manufacturing niobium phosphate according to claim 15, further comprising:
a third step of washing a compound obtained by said second step of addition of phosphoric acid with water and drying a resulting product.

23. The method for manufacturing niobium phosphate according to claim 12, wherein said compound obtained in said first step is niobium oxide having a volume averaged particle size as measured by a dynamic light scattering method of 0.9 nm to 12 nm.

24. The method for manufacturing niobium phosphate according to claim 13, wherein said compound obtained in said first step is niobium oxide having a volume averaged particle size as measured by a dynamic light scattering method of 0.9 nm to 12 nm.

25. The method for manufacturing niobium phosphate according to claim 14, wherein said compound obtained in said first step is niobium oxide having a volume averaged particle size as measured by a dynamic light scattering method of 0.9 nm to 12 nm.

26. The method for manufacturing niobium phosphate according to claim 15, wherein said compound obtained in said first step is niobium oxide having a volume averaged particle size as measured by a dynamic light scattering method of 0.9 nm to 12 nm.

27. The method for manufacturing niobium phosphate according to claim 16, wherein said compound obtained in said first step is niobium oxide having a volume averaged particle size as measured by a dynamic light scattering method of 0.9 nm to 12 nm.

28. Niobium phosphate manufactured by the method according to claim 12 and having a proton conductivity value of not lower than 5.3×10⁻⁵ Scm⁻¹.

29. Niobium phosphate manufactured by the method according to claim 13 and having a proton conductivity value of not lower than 5.3×10⁻⁵ Scm⁻¹.

30. Niobium phosphate manufactured by the method according to claim 14 and having a proton conductivity value of not lower than 5.3×10⁻⁵ Scm⁻¹.

31. Niobium phosphate manufactured by the method according to claim 15 and having a proton conductivity value of not lower than 5.3×10⁻⁵ Scm⁻¹.

32. Niobium phosphate manufactured by the method according to claim 16 and having a proton conductivity value of not lower than 5.3×10⁻⁵ Scm⁻¹.

33. Niobium phosphate manufactured by the method according to claim 17 and having a proton conductivity value of not lower than 5.3×10⁻⁵ Scm⁻¹.

34. Niobium phosphate according to claim 28 as an electrolyte material for a polymer electrolyte fuel cell.

35. Niobium phosphate according to claim 29 as an electrolyte material for a polymer electrolyte fuel cell.

36. Niobium phosphate according to claim 30 as an electrolyte material for a polymer electrolyte fuel cell.

37. Niobium phosphate according to claim 31 as an electrolyte material for a polymer electrolyte fuel cell.

38. Niobium phosphate according to claim 32 as an electrolyte material for a polymer electrolyte fuel cell.

39. Niobium phosphate according to claim 33 as an electrolyte material for a polymer electrolyte fuel cell.
